(19) United States
(12) Patent Application Publication
(10) Pub. No.: US 2015/0371168 A1
(43) Pub. Date: Dec. 24, 2015

(54) COLLABORATIVE PROJECT MANAGEMENT PLATFORM USING A PLACE-CENTRIC METHOD AND SYSTEM FOR CAPTURING AND ORGANIZING PROJECT INFORMATION

(71) Applicant: WAMOOZLE INC., King City (CA)

(72) Inventor: Walter KARABIN, King City (CA)

(21) Appl. No.: 14/746,808

(22) Filed: Jun. 22, 2015

Related U.S. Application Data
(60) Provisional application No. 62/015,512, filed on Jun. 22, 2014.
(60) Provisional application No. 62/096,332, filed on Dec. 23, 2014.

(51) Int. Cl. G06Q 10/06

(52) U.S. Cl. CPC G06Q 10/06313

(57) ABSTRACT

A computer-implemented method for organizing project information based on the location project resources are bound, and/or whereby information and/or communications are captured in the context of the location the information and/or communications pertains to, and/or a collaborative platform for facilitating communication between stakeholders to enable the stakeholders to work in tandem with the same information, wherein the information is organized with respect to location to support a particular workflow.

### CROSS-REFERENCE TO RELATED APPLICATIONS

This application claims the benefit of priority to U.S. Provisional Application Ser. No. 62/015,512, filed on Jun. 22, 2014; and U.S. Provisional Application Ser. No. 62/096,332 filed on Dec. 23, 2014.

### FIELD OF THE INVENTION

The present invention relates to a project management platform, more particularly it relates to a method and system for capturing, and organizing information in relation to a place for which the project resources are bound.

### DESCRIPTION OF THE RELATED ART

Project management involves coordinating various aspects of a project, and typically includes a plurality of elements such as personnel, materials, processes and facilities. Project managers are increasingly faced with a number of challenges related to cost, scheduling, quality, project performance, including communication between project stakeholders such as project managers, contractors, sub-contractors, trades, and clients. In most projects, it is not uncommon that unrealistic timelines are set, or that the vision and goals are not well-defined, and scope changes are not properly managed, or that risk is not properly managed and resources are not accurately determined or allocated.

At present, the market is awash with project management software tools which promise to assist project managers involved, however, not a single tool includes a comprehensive feature set for facilitating and managing project data capture. Accordingly, project managers are forced to cobble up different tools to achieve this goal. Not only is such a practice costly, it is also inefficient since valuable time is wasted inputting information into multiple systems. In addition, these disparate tools are seldom interoperable with each other and/or require expert knowledge to integrate them. Consequently, key information and crucial data related to the project is often not captured or is erroneously inputted, and therefore crucial project data may be lost, which may result in inaccurate metrics, wasted resources, and increased costs. Furthermore, these project management software tools are not tailored to the needs or workflows of any particular industry, such as home renovations, as they primarily organize information by time, resources, or person. This approach is largely deemed as being non-intuitive since most people view work in terms of places and tasks associated with those places.

It is an object of the present invention to mitigate or obviate at least one of the above-mentioned disadvantages.

### SUMMARY OF THE INVENTION

In one of its aspects, there is provided a computer program product comprising a non-transitory computer readable medium embodying computer readable code for creating an electronic message corresponding to a project, said computer program product comprising:

computer readable code for creating a window on a graphical user interface to include at least one location and at least one sub-location pertaining to said project and at least one project element type pertaining to one of said location and said at least one sub-location;

responsive to user selection of said at least one location and said at least one sub-location, computer readable code for displaying an object attributes window including a plurality of selectable attributes associated with said at least one location, said at least one sub-location;

responsive to user selection of one or more selectable attributes, computer readable code for associating selected attributes with said at least one location and said at least one sub-location and said at least one project element type object;

computer readable code for creating an editable free-form user interface element for population with said at least one location, said at least one selectable sub-location, said at least one object type and said plurality of selectable attributes associated therewith;

wherein said electronic message comprises said at least one location as an originator of said message, and one of said sub-locations and said at least one of said selectable attributes forms a subject of said electronic message, and said free-form content forms a body of said message; and

wherein said electronic message pertains to one of said at least one location and at least one of said plurality of selectable attributes, and wherein one of said at least one location and at least one of said plurality of selectable attributes is central to said communication method.

In another of its aspects, there is provided a communication method associated with a project, said project having at least one task with a plurality of sub-tasks in a workflow process, the method having the steps of:

determining a location and at least one sub-location where said at least one task is performed;

organizing at least one project element type pertaining to said project, wherein said at least one project element type comprises resources associated with said project including at least of one of time, personnel, equipment, products, and services;

assigning a first attribute to said location and a second attribute to said at least one sub-location, at a third attribute to said at least one of object type, wherein any of said first attribute, said second attribute and third attribute comprises at least one of features, metrics, descriptive information, communications, notes, and media;

presenting on a user interface a title of said project, said location and at least one selectable sub-location and at any of said first attribute, said second attribute and third attribute;

composing a message related to one of said location and at least one of said selectable attributes by:
selecting at least one of said sub-locations and selecting at least one of said attributes for populating an editable free-form user interface element; and
wherein said message comprises said location as an originator of said message, and one of said sub-locations and said at least one of said attributes forms a subject of said message, and said free-form content forms a body of said message; and
wherein said location and associated at least one of said selectable attributes is central to said communication method, such that said communication method is location-centric rather than user-centric.

In another of its aspects, there is provided, in a project management system, a computer-implemented method for managing information related to at least one project, said method having instructions stored in a computer-readable medium and executable by a processing structure to cause said processing structure to at least:

assign a user defined project identifier to said at least one project;

assign a unique place identifier to a location of said at least one project, and storing said unique place identifier to form a first level of a hierarchical data structure in a database;

assign a unique sub-place identifier to at least one sub-location of said at least one project, and storing said unique sub-place identifier to form a second level of said hierarchical data structure in said database;

assign a unique element identifier to at least one project element associated with said location and/or sub-location, said at least one project element having at least one feature, and storing said unique element identifier to form a third level of said hierarchical data structure in said database;

capture information pertaining to one said at least one project and assign said captured information to any one of said location and/or sub-location and attribute, and project element; and

whereby said assigned information is organized in terms with respect to said at least one location and/or said at least one sub-location.

In another of its aspects, there is provided, in a data processing system for a project management platform, a computer-implemented method for capturing data pertaining to at least one location of a project, the method having instructions stored in a computer-readable medium and executable by a processing structure to cause said processing structure to at least:

provide access to at least one user to said platform, wherein said at least one user has a predetermined user access privilege level to said platform;

present a graphical user interface (GUI) having a plurality of GUI objects for navigating said platform;

provide at least one input field for entering information pertaining to a title of said project, and assign a first unique identifier to said title of said project;

allow input of information pertaining to at least one location of said project, and assign a second unique identifier to said at least one location;

allow input of information pertaining to at least one sub-location of said at least one location of said project; and assign a third unique identifier to said at least one sub-location;

allow input of information pertaining to at least one attribute of said at least one sub-location of said at least one location; and assign a fourth unique identifier to said at least one attribute; and

whereby said title of said project, said at least one location, said at least one sub-location and said at least one attribute form a location-centric hierarchical structure of information pertaining to said project.

In another of its aspects, there is provided a project management system for capturing data pertaining to locations targeted in a construction project, said system having:

a project participants module having the functions of receiving and managing details of project stakeholders, such as contractors, sub-contractors, project team, vendors, trades, and clients; adding a project participant to a project team; assigning unique identifiers to members of said project team; and defining project roles of said project team;

a project place module having the functions of defining project locations; managing location-centric information related to locations or sub-locations for which project resources are bound;

a project calendar module having the functions of managing project milestone dates, allowing said project participants to identify major project milestones, enter new milestone activities; identify schedule tasks; add new schedule task; add a start date and an end date; and calculate schedule dates based on input of task data;

an Request for Quotes (RFQ) module having the functions of managing RFQs, and transmittals, submittals, change orders and deficiency lists associated with said RFQs; providing to said project participants, any of a summary and/or an overview of requirements and list of proposers, details describing the scope of services requested; providing quotes based on predetermined criteria and fee analysis to allow said project participants to determine variances between estimated, actual and other costs;

a media module having the functions of uploading and cataloguing of documents, images and multimedia; and providing linking of project specific information, including at least one of a title, description, daily report, and schedule;

an analytics and reporting module having the functions of analyzing information related to said project and generating reports, including at least one of a histogram, time line, bar chart, and tabular data; and providing forecasting based on resource constraints;

a communications module having the functions of exchanging and sharing of notes, multimedia, documents, comments between said project participants in a collaborative manner;

a search module having the functions querying data captured within said project management system; and

a project module having the functions of providing a summary of common project information to said project participants; providing task information to said project participants; sharing common data; providing a scope describing said project; identifying members of a project team; providing basic project data; assigning unique identifiers to each project or sub-project, place or sub-place associated with said project or sub-project and storing said unique identifiers in a database;

whereby said project information is organized by location; and

whereby said information and communications are captured in the context of a location targeted for said task in relation to said place it pertains to, to form a location-centric hierarchical structure of information pertaining to said project.

In another of its aspects, there is provided a communication method between a plurality of participants associated with a project, said project having at least one task having a plurality of sub-tasks, the method having the steps of:

determining a location and at least one sub-location where said at least one task is performed;

organizing at least one object type pertaining to said project, said at least one object type comprising one of said location, time, personnel, equipment, products, services;

assigning a first attribute to said location and a second attribute to said at least one sub-location, at a third attribute to said at least one of object type, wherein said attributes comprise at least one of features, metrics, descriptive information, personnel, time, work, said at least one task, said at least one sub-task, communications, notes, and media;

presenting on a user interface a title of said project, said location and at least one selectable sub-location and at least one selectable attribute

composing a message related to said location by:
selecting at least one of said sub-locations and selecting at least one of said attributes;
inputting data in a free-form user interface; and

whereby said message comprises said location as an originator of said message,

and
whereby one of said sub-locations and said at least one of said attributes forms a subject of said message and other of said attributes form a body of said message;
providing said message to at least one of said plurality of participants; and
whereby said at least one of said plurality of participants updates said message following said aforementioned steps; and
whereby said message pertains to one of said location and at least one of said selectable attributes, and one of said location and at least one of said selectable attributes is central to said communication method rather than participants.

In another of its aspects, there is provided a method of composing a message associated with a project, said project having at least one task having a plurality of sub-tasks, the method having the steps of:

determining a location and at least one sub-location where said at least one task is performed;

organizing at least one object type pertaining to said project, said at least one object type comprising one of said location, time, personnel, equipment, products, services;

assigning a first attribute to said location and a second attribute to said at least one sub-location, at a third attribute to said at least one of object type, wherein said attributes comprise at least one of features, metrics, descriptive information, personnel, time, work, said at least one task, said at least one sub-task, communications, notes, and media;

presenting on a user interface a title of said project, said location and at least one selectable sub-location and at least one selectable attribute;

composing a message related to said location by:
selecting at least one of said sub-locations and selecting at least one of said attributes;
inputting data in a free-form user interface; and

whereby said message comprises said location as an originator of said message,

and
whereby one of said sub-locations and said at least one of said attributes forms a subject of said message and other of said attributes form a body of said message;
providing said message to at least one project participant; and
whereby said at least one of said plurality of participants updates said message following said aforementioned steps; and
whereby said message pertains to one of said location and at least one of said selectable attributes, and one of said location and at least one of said selectable attributes is central to said message rather than said at least one project participant.

Current project management systems generally rely on the obvious typical elements such as time, dates, costs, people, and tasks as their core while neglecting the actual location in which all the resources are intended to converge, that is, the place. Advantageously, in one embodiment the system or workflow process captures information and communications intuitively in terms of “place” or location to solve this discrepancy, as people naturally think and work in terms of objects and places. Information organized by “place” reflects the way in which people naturally approach and carry out project tasks, in contrast to time/resource oriented software.

Therefore, project information elements such as, costs, tasks, communications, features, attributes, times, dates, and notes are connected by place and provide useful, fast reports, and eliminate redundancy in report creation by means of leveraging user inputs typical to project related processes. Typical project-related processes requiring user inputs are found when a user captures, organizes, or interacts with project information in a variety of ways or applications such as word-processing, spreadsheets, electronic messages, calendar, contact lists, day-timers, paper note pads, and stand-alone software. In addition, complete details of current and past projects are organized and captured in one place; and the system provides a medium of communication that gives context to the information being exchanged i.e. place-centric. A collaborative platform which facilitates communication between stakeholders by allowing them to work in tandem with the same information is provided, wherein the information is organized to support a particular workflow. Consequently, project efficiency and profitability are substantially enhanced.

In addition, the system or workflow process provides the project stakeholders with the ability to balance competing demands, define a clear project scope, identify project risks and identify potential problems in a timely manner, provide a consistent method for monitoring and controlling project deliverables and milestones, improved communication among stakeholders, measure project performance and understand the impact of the timeline and critical path when deliverables are changed.

### BRIEF DESCRIPTION OF THE DRAWINGS

Several exemplary embodiments of the present invention will now be described, by way of example only, with reference to the appended drawings in which:

FIG. 1 is a top-level component architecture diagram of an exemplary project management system;

FIG. 2 shows a schematic diagram of a general purpose computer system;

FIG. 3a shows an exemplary embodiment of a database having a location-centric hierarchical structure of information pertaining to the project;

FIG. 3b shows a high level flow diagram illustrating exemplary process steps for building a place-centric hierarchical structure of information;

FIG. 3c shows an exemplary embodiment of another database having a location-centric hierarchical structure of information pertaining to the project resulting from the process of FIG. 3b;

FIG. 4 shows a location-centric hierarchical structure of information pertaining to the project;

FIG. 5 shows another high level flow diagram illustrating exemplary process steps for building a place-centric hierarchical structure of information;

FIG. 6 is a screenshot of an exemplary user interface;

FIG. 7 is a screenshot of an exemplary user interface;

FIG. 8 is another screenshot of an exemplary user interface;

FIG. 9 is another screenshot of an exemplary user interface;

FIG. 10 is yet another screenshot of an exemplary user interface;

FIG. 11 is yet another screenshot of an exemplary user interface;

FIG. 12 is a screenshot of an exemplary user interface;

FIG. 13 is another screenshot of an exemplary user interface;

FIG. 14 is another screenshot of an exemplary user interface;

FIG. 15 is another screenshot of an exemplary user interface;

FIG. 16 is yet another screenshot of an exemplary user interface;

FIG. 17 is yet another screenshot of an exemplary user interface;

FIG. 18 is yet another screenshot of an exemplary user interface; and

FIGS. 19a to 19e are other screenshots of an exemplary user interface.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

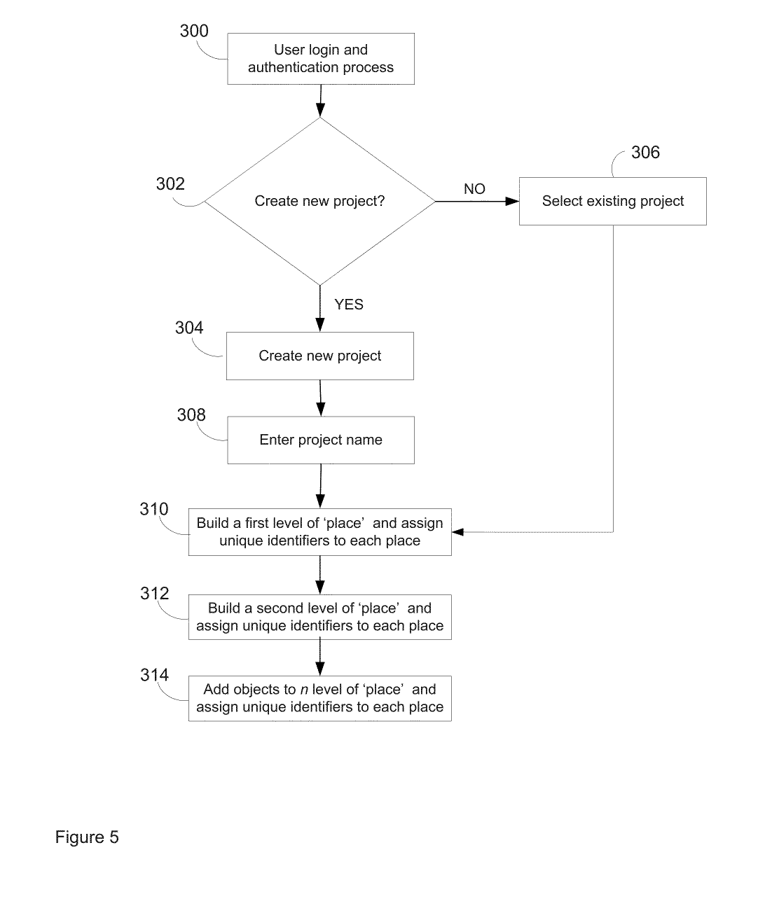

FIG. 1 shows a top-level component architecture diagram of an exemplary system, generally identified by reference numeral 10, for performing a place-centric project management process. System 10 generally includes one or more user devices 12 coupled to computing system 14 via communications network 16, such as the Internet, and/or any other suitable network. Examples of a computing system 14 may include, but are not limited to: a personal computer, a server computer, a series of server computers, a mini computer, and a mainframe computer. In one example, server computer 14 comprises project management framework module 18, and includes a project management process that may be executed by a data processing system of server computer 14, as will be described below with reference to FIG. 5. Server computer 14 includes one or more databases 20, which may be any type of data repository or combination of data repositories, which store records or other representations of data.

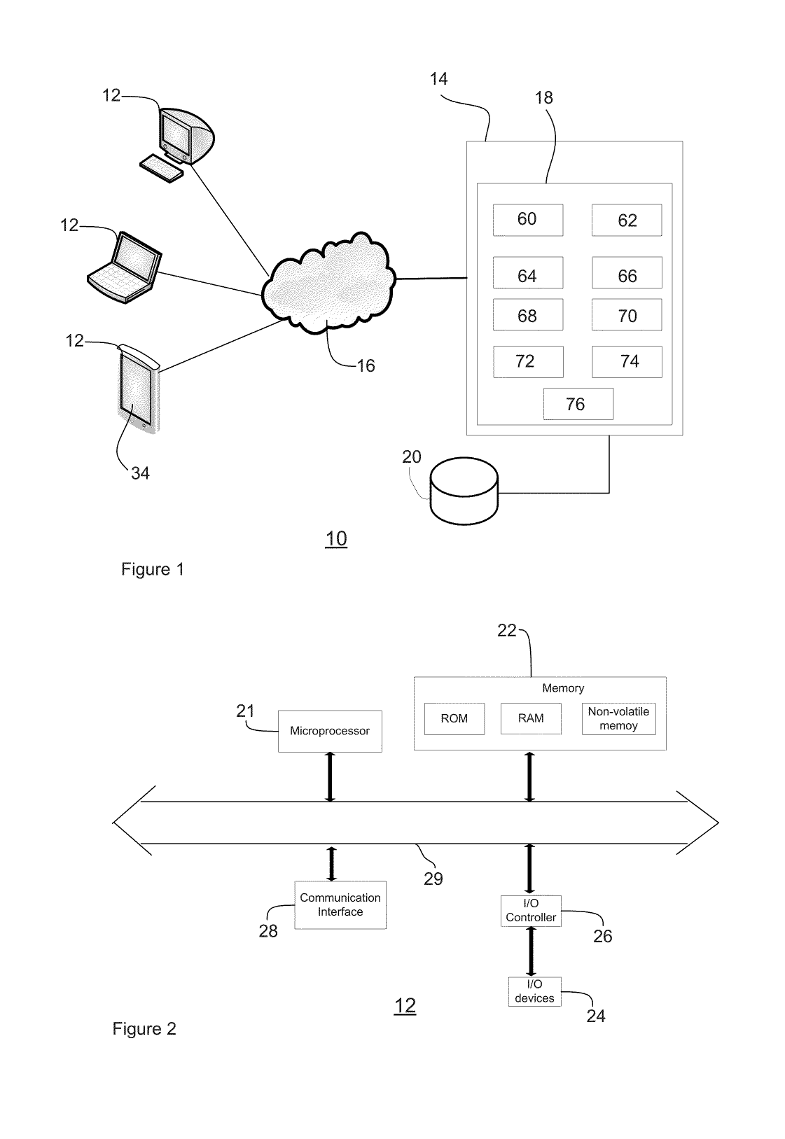

The methods of the invention are performed with a digital processing system, such as a conventional, general purpose computer system. Special purpose computers which are designed or programmed to perform only one function may also be used. FIG. 2 shows a schematic diagram of a user device 12 depicted as a general-purpose computer system in which a place-centric project management process operates. The general-purpose computer system 12 comprises, for example, a processing unit, such as processor 21, system memory 22. The computer system 12 also includes as input/output (I/O) devices 24 coupled to the processor 21 via an I/O controller 26. The input/output (I/O) devices 24, for example, a keyboard, mouse, trackball, microphone, touch screen, a printing device, display screen, speaker, etc. A communications interface device 28 provides networking capabilities using Ethernet, WiFi™, and/or other suitable network format, to enable connection to shared or remote drives, one or more networked computers, or other networked devices, via the communications network 16. The components of computer system 12 may be coupled by an interconnection mechanism 29, which may include one or more buses (e.g., between components that are integrated within a same machine) and/or a network (e.g., between components that reside on separate discrete machines). The interconnection mechanism 29 enables communications (e.g., data, instructions) to be exchanged between components of system 12.

Various aspects of the invention may be implemented as specialized software processes with instructions having computer readable code executable in one or more computer systems communicating over network 16. Processor 21 executes sequences of instructions contained in memory 22, such as a machine readable medium. Machine readable medium 22 includes any mechanism that provides (i.e., stores and/or transmits) information in a form accessible by a machine (e.g., a computer, network device, personal digital assistant, a smartphone, any device with a set of one or more processors, etc.). For example, machine readable media includes recordable/non-recordable media 22 (e.g., read only memory (ROM); random access memory (RAM); magnetic disk storage media; optical storage media; flash memory devices; a hard disk drive, etc.), as well as electrical, optical, acoustical or other forms of propagated signals (e.g., carrier waves, infrared signals, digital signals, etc.). Such a processor 21 usually executes an operating system which may be, for example, the Windows-based operating systems (e.g., Windows NT, Windows 7, Windows 8 operating systems) available from Microsoft Corporation, MAC OS System X operating system and iOS available from Apple Computer, Android from Google Inc., and one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

As described in more detail below, the project management module 18 may be adapted to configure server 14, when executed thereby, to perform or manage one or more aspects the project. These aspects may be, for example, any of scope, cost, quotes, and scheduling, communication, analytics, data visualization, tasks, workflow, calendaring, project participants, documents, and media, pertaining to the project. Accordingly, project management module 18 may include one or more directives, settings, rules, expressions, characteristics, parameters, commands and so forth.

Project management module 18 may include a number of modules which perform various functions. For example, project management module 18 may include any of a project module 60, project participants module 62, project place module 64, project calendar module 66, RFQ (Request for Quotes) module 68, media module 70, analytics and reporting module 72, communications module 74 and search module 76. Each of these modules 60 to 76, in general includes computer code including instructions executable by the server 14 or equivalent device, and may be independently loadable from long-term storage media (such as, but not limited to, a disk drive, CD-ROM, tape, or the like). Modules 60 to 76 may also include function, routines, subroutines, processes, dynamic link libraries (DLLs) and the like. In addition, any one of these modules 60 to 76 may include sub-modules for performing portions of the functions, routines, subroutines, and processes.

Project module 60 may include the functions of providing a summary of common project information to all project participants; providing the task information to project participants without having to recreate such task information; sharing common data; providing a scope describing the project; providing; identifying the members of a project team; providing basic project data; providing a project title and address; providing an owner name and address; providing descriptions and categories for a project; assigning unique identifiers to each project or sub-project and storing them in database 20. Generally, database 20 comprises a plurality of containers, such as container “place”, “sub-place”, and “project information element”, and includes files with different data types having data and associated metadata stored in the designated containers.

Project participants module 62 includes the functions of receiving and managing details of the project stakeholders, such as contractors, sub-contractors, project team, vendors, trades, and clients. Project participants module 62 also allows addition of a team member to a project; assigning unique identifiers to members of a project team; and defining project roles that may be shareable across the project.

Project place module 64 allows a user to define project locations; and manages location-centric information related to locations or sub-locations for which the project resources are bound, i.e. “places” and “sub-places”. For example, in a renovation project involving a remodelling of a bathroom, the bathroom is considered a “place ” while a shower stall is considered a “sub-place” within the “place”. Project place module 64 also allows a user to define elevations for a building or structure; define the floors in a building or structure; and define rooms on a floor.

Project calendar module 66 manages project milestone dates, and allows users to identify major project milestones. For example, project calendar module 66 allows users to enter new milestone activities; identify schedule tasks; add a new schedule task; add a start date and an end date; calculate the schedule dates based on input of task data.

RFQ (Request for Quotes) module 68 manages RFQs, transmittals, submittals, change orders and deficiency lists. RFQ module 68 also allows adding and listing of new RFQs; providing, to the project participants an indication or electronic notification of a RFQs due date and time; publishing RFQs; providing to the project participants, any of a summary and/or an overview of requirements, details describing the scope of services requested. RFQ module 68 may also provide quotes based on predetermined criteria and fee analysis, and allows a user to determine variances between estimated, actual and other costs.

Media module 70, allows uploading and cataloguing of documents, images and multimedia; providing linking of project specific data/information, for example, title, description, daily report, schedule, to a media objects, such as an image.

Analytics and reporting module 72 analyzes information related to the project and generates a variety of reports, such as, histograms, time lines, bar charts, and tabular data, and so forth, using data visualization techniques. Such reports may be useful in optimizing project execution and resource utilization, such as personnel, parts, inventory, equipment, tools, etc. Analytics and reporting module 72 can also provide forecasting based on resource constraints such as tools, inventory or manpower.

Communications module 74 allows exchange and sharing of notes, multimedia, documents, comments between the project stakeholders, in a collaborative fashion.

Search module 76 allows querying of data captured within the project management system 10.

A user, or project participant, can gain access to system 10 to create, access or manage any number of projects on that particular system 10. User-level security provides control over what individual users can create, access or manage within various parts of the system.

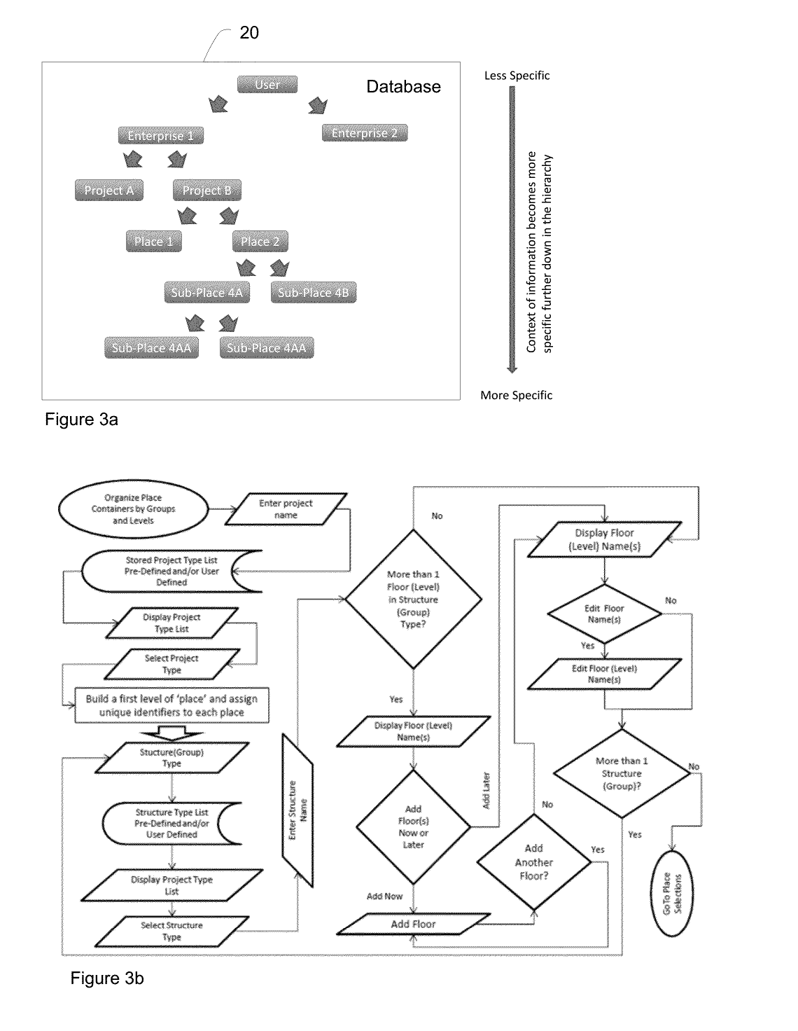

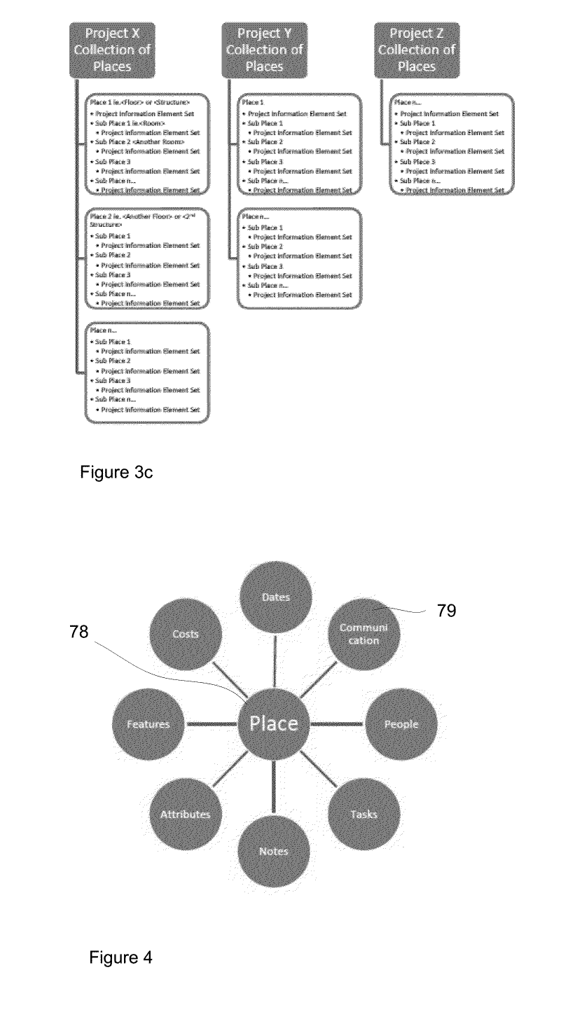

Each project is associated with a first level of places where tasks are to be performed, and the first level of places may include a second level of places or additional sub-places, and so forth, such that a project may comprise a plurality of levels of spaces (n levels), each level being uniquely identified, and including information or records specific to that level. Accordingly, the context of information regarding the project becomes more specific further down in the hierarchy from level 1 to level n. For instance, in the above example a user is able to drill-down to the minutiae of details about the project, such as the lighting plan for a family room, and may include the type of lighting (manufacturer, wattage, SKU, etc.), quantity of the light bulbs, cost, location for installation based on the dimensions of the family room (length, width, ceiling height), responsible team member for installation, scheduled install date, task duration, etc. FIG. 3a shows an exemplary embodiment of the database 20 having a location-centric hierarchical structure of information pertaining to the project.

Turning to FIG. 3b, there is shown a high level flow diagram illustrating exemplary process steps for building a place-centric hierarchical structure of information. FIG. 3c shows an exemplary embodiment of a database having a place-centric hierarchical structure of information pertaining to the project resulting from the process of FIG. 3b. Exemplary projects X, Y and Z, in FIG. 3c, include a collection of places, such that information that is captured is immediately or subsequently assigned or re-assigned according to a Place container [Place n] or any sub-container [Sub-Place n] or any feature set container [Project Information Element Set] inside a place or sub-place specific to the parent collection container [Project X, Y, Z etc.], i.e. place-centric assignment. In one example, a renovation project at a client's property (Ms. Smith) is assigned the moniker “Project Smith”, with work to be performed in the house (Place 1) i.e. structure, on the second floor (Sub-Place 1) and in the master bedroom (Sub place 1a) and guest bathroom (Sub place 1b). The project also calls for work to be performed on another structure on Ms. Smith's property, a cabana (Place 2), and specifically to the roof (Sub-place 2a); and yet another structure garage (Place 3), requires work on the garage door (Sub place 3a). Therefore, Project Smith includes a collection of places, which are structures: house; cabana and garage; and a plurality of sub-places related to those places slated to be worked on i.e. guest bathroom and master bedroom on the second floor of the house, the roof of the cabana and the door on the garage. In yet another example, a renovation project at a commercial building (ACME Corp.) is assigned the moniker “Project ACME”, with work to be performed on the ground floor (Place 1) i.e. place, in the warehouse (Sub place 1a), and the cafeteria (Sub place 1b), and specifically to the cafeteria washroom (Sub place 1c). The project also calls to work to be performed on the 4^{th} floor (Place 2), and specifically to the north-east corner office (Sub-place 2a). Therefore, Project ACME includes a collection of places which are floors: ground floor and 4^{th} floor, and a plurality of sub-places related to those places slated to be worked on i.e. the warehouse and the cafeteria on the ground floor, and north-east corner office on the 4^{th} floor. The place centric assignment occurs in one or more positions in the user's workflow. The assignment of any information captured in any project information element can be edited or copied; or the data or information can be re-assigned automatically or manually with the relocation of the information once the information is captured within the program application. Alternatively, the information can be re-assigned automatically if the information is copied and pasted within the program application. Thus, the project place centric information elements keep their original identity in addition to a new identity such that the program maintains project information element place centric identity for the purpose of version control or audit trail queries.

As shown in FIG. 4, Place 78 is the hub through which multiple relationships are formed. Place-centricity affords information and data to be captured, organized, and interacted with in a workflow process to deliver novel non-obvious user capability and efficiency. Project information elements 79 each containing their specific information is or can be in the future linked through a common relationship i.e. Place 78. Any one project element 79 or any combination of elements 79 as they relate to Place 78 yields new opportunities for information management, understanding and interaction. The terms “project information element” and “project element”; and the terms “space” and “place” will be used interchangeably throughout the specification.

Place 78 is an object container around which typical project information elements 79, such as time; notes; costs; dates; meetings; tasks; communication, and people revolve. Accordingly, project information can be captured, organized, and interacted with in a new way and afford users unique experiences to exercise their capabilities and increase productivity when managing project information. This enhances user workflows and contributes to improved efficiency and cost reduction through time spent capturing, storing, filing, managing, communicating, compiling, searching, sending, receiving, researching, and accuracy of information management.

Place-centricity offers a plurality of benefits, such as immediate and relevant connection with project information elements 79 based on Place 78. Day to day activities revolve around Place 78 and with place-centric project management so too can project information.

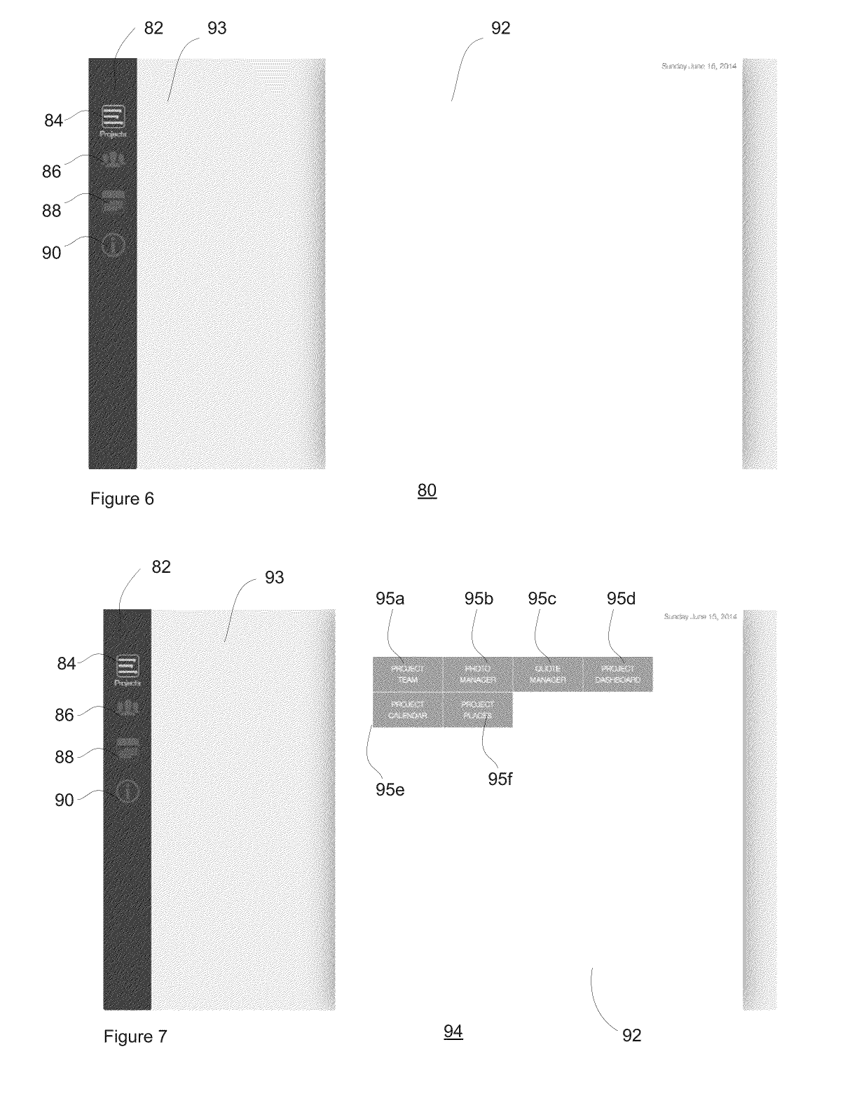

In one exemplary embodiment, FIG. 5 shows exemplary process steps for building a place-centric hierarchical structure of information pertaining to a renovation project. A hierarchical relationship is established between place-centric projects within system 10 comprising an overall project wherein the overall project has a parent/child relationship to places and sub-places. Following a user login and authentication process (step 300), the user is presented with an exemplary first graphical user interface (GUI) 80, as depicted in exemplary screenshot of FIG. 6. First GUI 80 includes one portion 82 with a plurality of GUI objects, such as buttons or icons 84, 86, 88 and 90 for navigating the system 10, a second portion 92 and an intermediate portion 93. For example, button 84 is associated with projects available on a particular system 10, and allows creation, edition, and deletion of projects, as will be described below with reference to FIG. 3a. Button 86 is associated with stakeholders of projects within the enterprise, and provides access all stakeholders, such as employees, contractors, sub-contractors, vendors, suppliers, trades, companies, clients, and others within the system 10. Given proper access permissions, any one of the stakeholders may access and view information pertaining to the place or sub-places, such as review changes or variances made to project scope and schedules, or edit the project scope and schedules. Button 88 provides access to shared, enterprise calendars, such as a resource calendar, task calendar, project calendar, and corporate calendar. Button 90 allows a user to perform queries on data captured within the system 10 and stored in database 20. Accordingly, buttons or icons 84, 86, 88 and 90 provide access to enterprise project information pertaining to, but not limited to, people or team participating on a project, photos, documents, media, quotes, RFQs, metrics, analytics, data visualization, calendar, tasks, workflow, places, and sub-places.

Turning now to FIG. 7, there is shown an exemplary second GUI 94, with second portion 92 displaying content related to buttons or icons 84, 86, 88 and 90. In this example, button 84 labelled “Projects” is selected and various buttons 95a to 95e representing different ways to navigate information within a selected project are displayed in portion 92. For example, button 95a is labelled “PROJECT TEAM” and when selected, button 95a causes participants module 62 to perform functions related to stakeholders, as described above. Correspondingly, button 95b labelled “PHOTO MANAGER” is linked to media module 70; button 95c labelled “QUOTE MANAGER” is linked to RFQ module 68; button 95d labelled “PROJECT DASHBOARD” is linked to project module 60 and analytics and reporting module 72; button 95e labelled “PROJECT CALENDAR” is linked to project calendar module 66 and button 95f labelled “PROJECT PLACES” is linked to project place module 64; and selection of any of these buttons 95a to 95f causes the respective linked module to perform its set functions as described above. In any project, information in each ‘place’ can be accessed by navigating to that place, or alternatively by navigating to the information type and managing which places the information is relevant to.

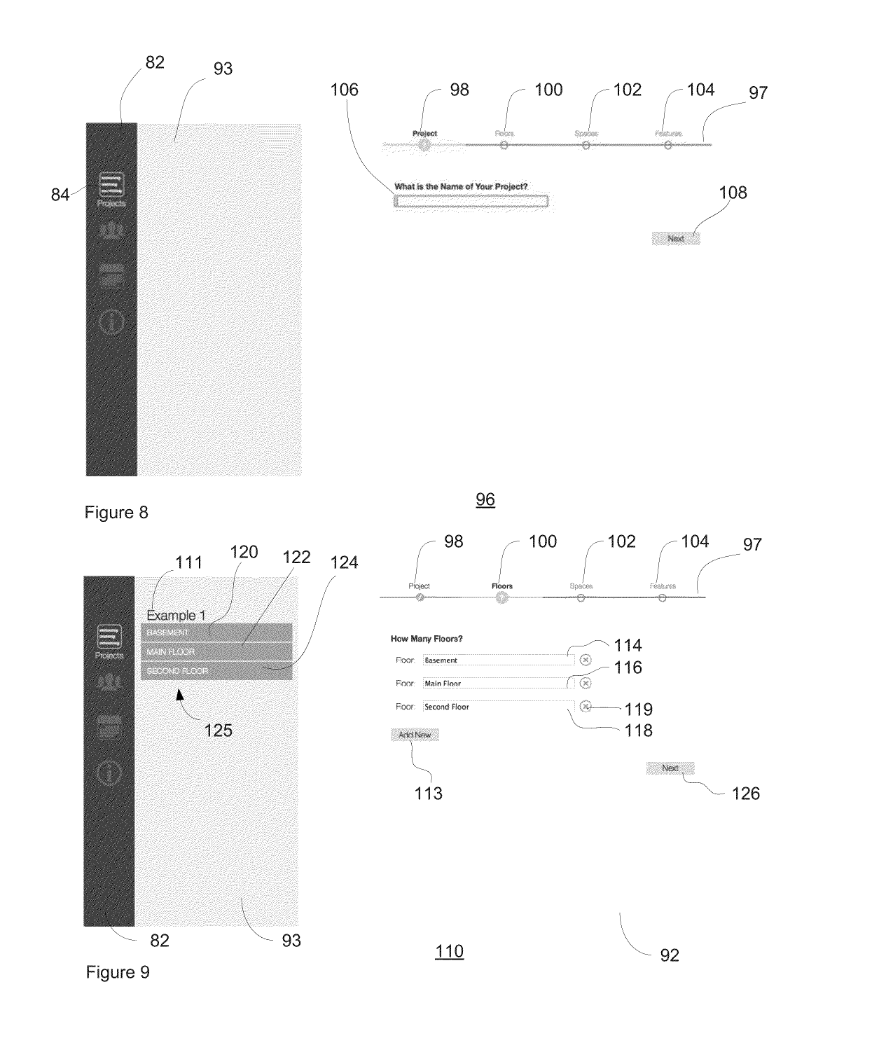

In one example, in order to start building a place-centric hierarchical structure of information pertaining to a renovation project, button 95d is actuated, and the user is provided with an option to create a new project and an option to select a previously created project (step 302). When the election to start a new project is made, then a new project build begins (step 304), otherwise when one of the existing projects is selected (step 306), the process moves on to step 310, as will be described below. As shown in exemplary screenshot of FIG. 8, an exemplary GUI 96 comprises a progress bar 97 is disposed within portion 92, and includes a project icon 98, floors icon 100, spaces icon 102 and features icon 104. Project icon 98 is highlighted to indicate in-progress input activity related thereto, while other icons 100, 102 and 104 are grayed out to show inactivity or that input fields related thereto have yet to be populated. An input field 106 receives a name for the new project from the user. Inputting the project name and selecting next icon 108 causes search module 76 to query database 20 to determine whether the inputted project name, such as “Example 1” is associated with any other enterprise projects. If there is a match, then an appropriate error message is posted instructing the user to choose another name, otherwise “Example 1” is assigned a unique project identifier by the project module 60 (step 308), and the unique project identifier is stored in database 20 to form part of the eventual comprehensive data for analytics and report creation. Step 308 may also include sub-steps of entering details pertaining to a client, start date, completion date, milestones, deliverables, and other basic project information. Accordingly, this project-level information is useful for reference, generation of meta-data, and organization.

In next step 310, third GUI 110 is presented, and thereon a user may build a first level of ‘place’ which will be used to organize and subdivide all project information by the place to which it pertains. As shown in exemplary screenshot of FIG. 9, project icon 98 on progress bar 97 is now associated with indicia, such as color or a checkmark to indicate successful completion of the previous step 302. Floors icon 100 is now highlighted to indicate in-progress input activity related thereto, while icons 102 and 104 are still grayed out. The name of project 111 i.e. “Example 1” is displayed in third portion 93 intermediate first portion 82 and second portion 92. A user is able to add a number of floors of the house or building structure by selecting “Add new” button 113, and each floor type may be specified, such as basement, first floor and second floor using drop-down menus 114, 116 and 118. Floors may be deleted by selecting a “delete” icon 119 adjacent to each of the drop down menus 114, 116 and 118. Each of the floors is assigned a unique space identifier by the project module 60, and the unique space identifiers are stored in database 20. As the floors are added, they also appear below project name 111 as hyperlinked floor buttons 120, 122 and 124, and so forth, to form floor button panel 125. It should be noted that various types of visually-cued ‘hyperlinked’ GUI objects can be employed, and can include underlined, highlighted, and/or colored text, images or regions within images, etc.) operable by a pointing device via input events such as clicking when the screen cursor is overlaid or sufficiently close to the spatial location of the visual cue. To advance to the next step 312, “Next” button 126 is selected.

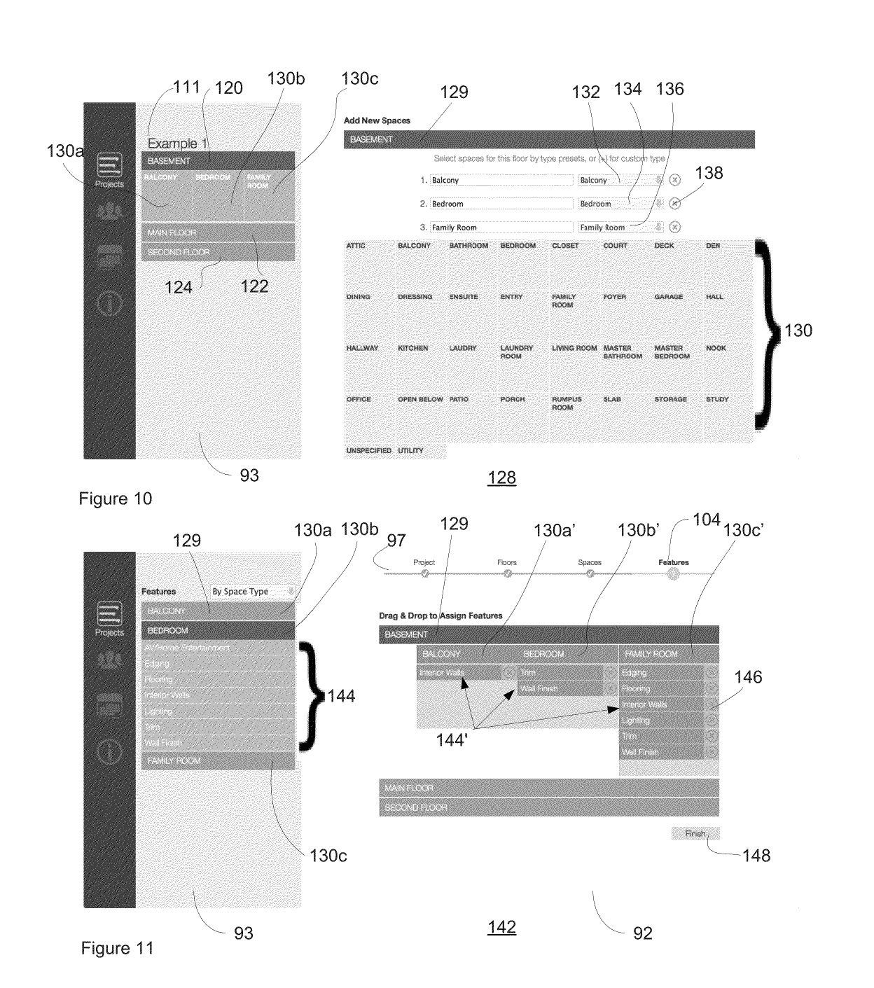

In the next step 312, following actuation of button 126, a fourth GUI 128 is presented, on which a user may build a second level of ‘places’ within each of the first level of places i.e. floor type, to build out a hierarchical place-based structure used to capture and display information. As shown in exemplary screenshot of FIG. 10, project icon 98 and floors icon 100 on progress bar 97 are now associated with indicia, such as color or a checkmark to indicate successful completion of the previous steps 304 and 310, while spaces icon 102 is highlighted to indicate in-progress input activity related thereto, icon 104 is still grayed out (not shown). A user is able to add spaces to the predefined number of floors of the house or building structure. For example, in FIG. 10, when “BASEMENT” floor is selected from the intermediate portion 93, then floor title 129 “BASEMENT” is displayed in second portion 92, and a plurality of space choices 130 appear below floor title 129. Spaces 130 may be dragged and dropped onto the desired onto the desired room on buttons 120, 122 and 124. The space choices may include any of an attic, balcony bathroom, closet, court, deck, den, dining room, dressing, ensuite, entry, family room, foyer, garage, hall, hallway, kitchen, laundry, laundry room, living room, master bathroom, master bedroom, nook, office, open below, patio, porch, rumpus room, slab, storage, study, utility and custom space. As spaces 130 are added, such as “BALCONY” 130a, “BEDROOM” 130b and “FAMILY ROOM” 130c, they appear below button 120 corresponding to the “BASEMENT” floor. Correspondingly, if spaces 130 are added to the “MAIN FLOOR” 122, then the desired spaces 130 would appear below button 122, and so forth. In portion 92, drop-down menus 132, 134 and 136 allow the user to select a preset space type, and enter a customized description of the floor in input fields 137a, 137b and 137c. Any of these spaces may be deleted by selecting “delete” icon 138 adjacent to each of the drop down menus 132, 134, 136. Each of the spaces are assigned a unique space identifier by the project module 60, and the unique space identifiers are associated with the unique place identifier and the unique project identifier, and stored in database 20. To advance to the next step 314, “Next” button 140 is selected.

In the next step 314, following actuation of button 140, fifth GUI 142 is presented, and thereon a user may add features to desired space 130 of basement room associated with button 120, 122 or 124. As shown in exemplary screenshot of FIG. 11, project icon 98, floors icon 100 and spaces icon 102 on progress bar 97 are now associated with indicia, such as color or a checkmark to indicate successful completion of the previous steps 302, 304, 306 while features icon 104 is highlighted to indicate in-progress input activity related thereto. A user is able to add features 144 to spaces 130 by assigning items, objects, information, communications, people, times, work, tasks, media, or other data. For example, in FIG. 10, when “BASEMENT” floor button 120 is selected from the intermediate portion 93, then “BASEMENT” floor label 129 is displayed in second portion 92. In intermediate portion 93, a space type of the “BASEMENT” may be selected using drop-down menu 146 to choose between “BALCONY” 130a, “BEDROOM” 130b and “FAMILY ROOM” 130c. For example, features 144 available for “BEDROOM” 130b may include AV/home entertainment, edging, flooring, interior walls, lighting, trim and wall finish. Any of these features 144 appearing in intermediate portion 93 may be added by dragged and dropped to the desired space “BALCONY” 130a′, “BEDROOM” 130b′ and “FAMILY ROOM” 130c′ appearing in second portion 92, such that identical features 144′ appear below the desired space 130a′, 130b′ or 130c′. Each of the added features 144′ appearing in second portion 92 are associated with a “delete” icon 146 to allow deletion of a feature 144′. The assignment may be performed individually or as a group. Each of the features are assigned a unique feature identifier by project module 60, and the unique feature identifiers are associated with the unique space identifier, unique place identifier and the unique project identifier, to form a place-centric hierarchical data structure, which is stored in database 20. When the features 144 have been added, a “Finish” button 148 is selected, and process ends.

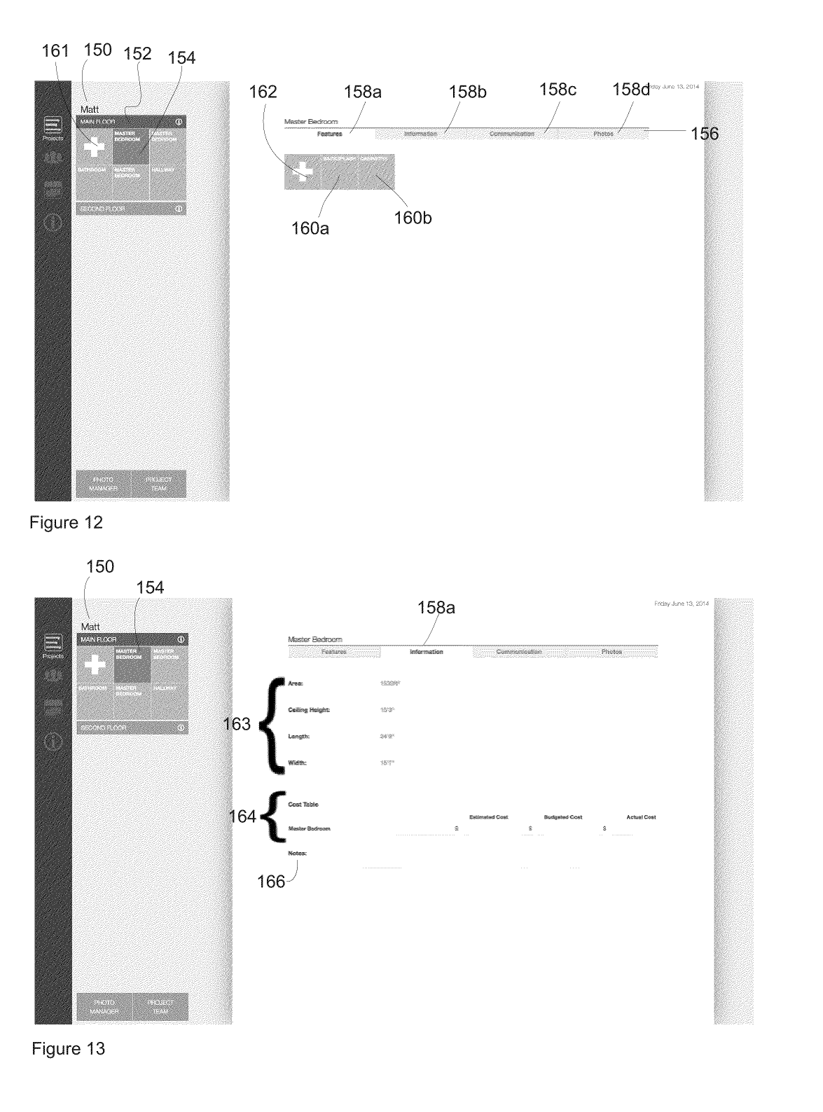

Now turning to FIG. 12, there is shown an exemplary screenshot depicting information captured and displayed, such as, features and selections associated with a first level of place, containing sub-places in clickable accordion 149. Sub-places, contained by accordions representing the first level of places within the project. Each sub-place is clickable to reveal information that pertains to that place specifically. Accordingly, a container ‘Place’ within database 20 comprises data types such as, but not limited to objects, features, metrics, descriptive information, people, times, work, tasks, communications, notes, media. For example, in FIG. 12, there is shown a project identified as “MATT” 150 in intermediate portion 93 with a floor associated with “MAIN FLOOR” button 152 with a master bedroom sub-place associated with “MASTER BEDROOM” button 154. A type navigation bar 156 associated with the master bedroom is displayed in second portion 92, and includes data types represented by features button 158a, information button 158b, communications button 158c and photos button 158d. In this example, selecting features button 148 causes the display of the following features: “BACKSPLASH” 160a and “CARPENTRY” 160b in second portion 92. Additional sub-places to the main floor may be added by selecting an “add” tile 161 in accordion 149. Correspondingly, additional features to master bedroom associated with sub-place “MASTER BEDROOM” 154 may be added selecting an “add” tile 162 in portion 92.

In FIG. 13, there is shown another exemplary screenshot depicting various metrics and descriptive data captured and displayed as they pertain to a place, such as a master bedroom. For example, selecting the information button 158b displays various metrics corresponding to the master bedroom, such as, dimensions 163 of the master bedroom such as area, ceiling height, length and width; including a cost table 164 for the master bedroom, such as estimated cost, budgeted cost and actual cost, as well as notes 166.

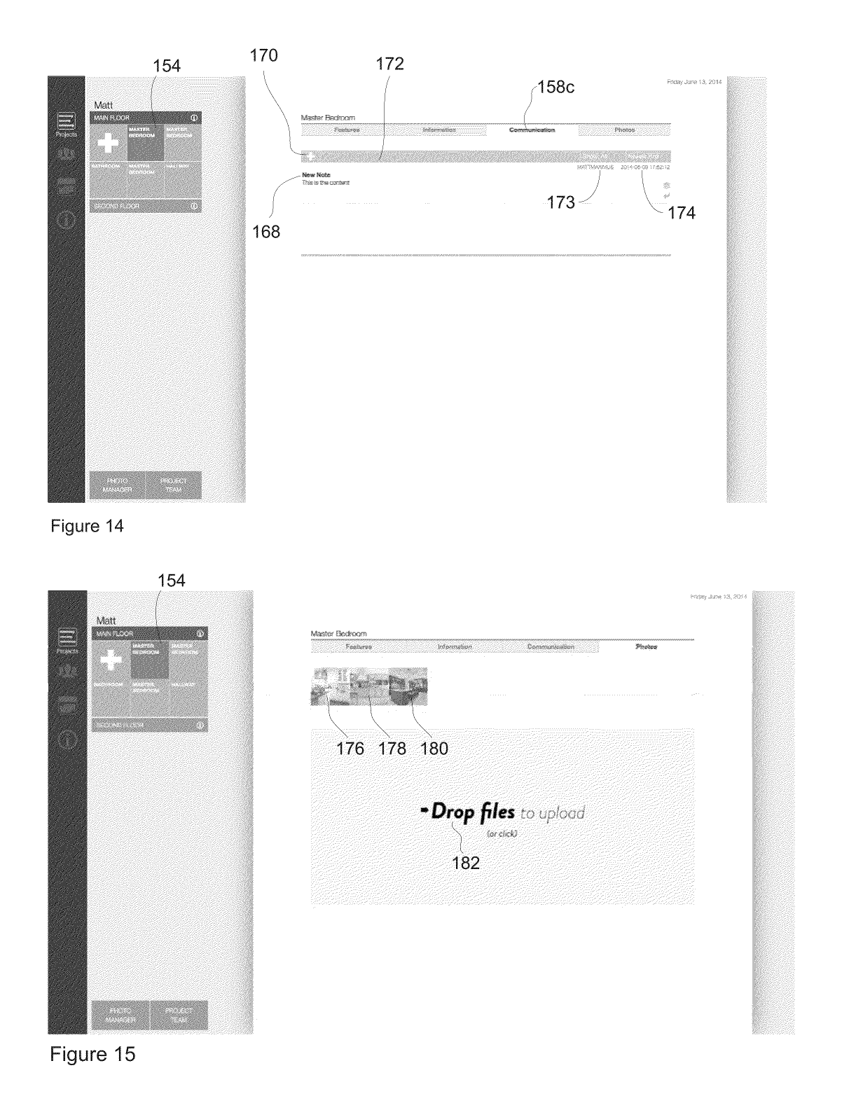

In FIG. 14, there is shown yet another exemplary screenshot depicting communications and notes captured and displayed as they pertain to a place, such as a master bedroom. When communications button 158c is selected, all communications related to the master bedroom place are displayed in portion 92. Notes 168 may be added by selecting “add” icon 170 on task bar 172 and include originator 173 of note 168 and an automatic date stamp 174 pertaining to note 168. When note 168 is posted, an alert is sent to all stakeholders for which that note 168 has relevance.

At any point in a user's workflow the notes input function can be executed to capture notes, therefore the function may be executed anywhere in the program application and at any level of place (project level/floor level/place level/ sub-place/place feature/place page views). Accordingly, notes are captured in the place where the user executes the notes function, such that the notes are automatically assigned to the place in which the program executes the notes input function. Notes can be reassigned or copied to other places. In one example, a red button, or other indicia, is employed to signify a note capture mode in the program application. When executed, a notes window is launched and overlays the active window during mid-workflow, as the need to capture notes in a project can arise at any time for the user. The notes window minimizes distraction to the user and allows the interruptive process of notes capture to occur and then allow the user to get back to their previous task or state of workflow. The note assignment is by default auto-populated from the space in which the notes window is opened, this assignment option is firstly auto-populated and can then be editable or re-assignable by selection from a list once the relationship is populated or established. The notes can be filtered, stored, referenced, accessed, served in a database, viewed, reported on, or edited by one or more users by place-centric assignment.

In FIG. 15, there is shown an exemplary screenshot depicting photos and media uploaded/captured and displayed as it pertains to a place, such as a master bedroom. For example, when photos button 158c is selected, photos related to the master bedroom place is displayed in portion 92, such as photos 176, 178, 180. Additional images may be added by selecting an “Upload” icon 182.

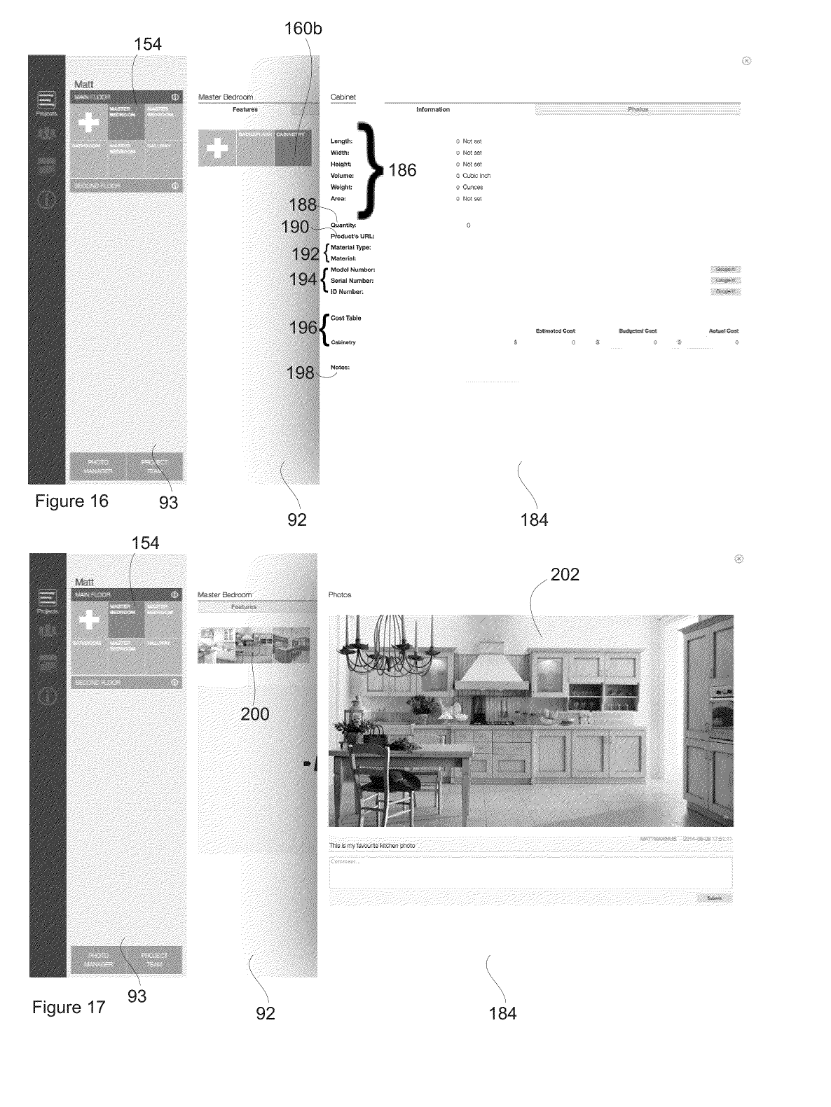

In FIG. 16, there is shown an exemplary screenshot depicting information overlays revealing more information within a place, such as a master bedroom, such that a second portion 184 (now reduced in size) shows features “BACKSPLASH” 160a and “CARPENTRY” 160b. When features tile “CARPENTRY” 160b is selected from the second portion 92 in FIG. 11, then more detailed information pertaining to the carpentry is displayed in a sub-portion 184 of second portion 92, via a sliding motion. The detailed information may include dimensions 186, such as, length, width, volume, weight, area; quantity 188, product URL 190, material characteristics 192, product identification information 194, such as model number, serial number and ID number, and cost table 196 for the carpentry, such as estimated cost, budgeted cost and actual cost, as well as notes 198.

In FIG. 17, there is shown an exemplary screenshot depicting information overlays revealing more information within a place, such as a master bedroom, such that photos, documents, other media added in FIG. 13 may be selected in the second portion 92 and previewed or displayed in an enlarged format in sub-portion 184. For example, image 200 of cabinetry is selected in second intermediate portion 184 and a corresponding enlarged version 202 is displayed in second portion 92.

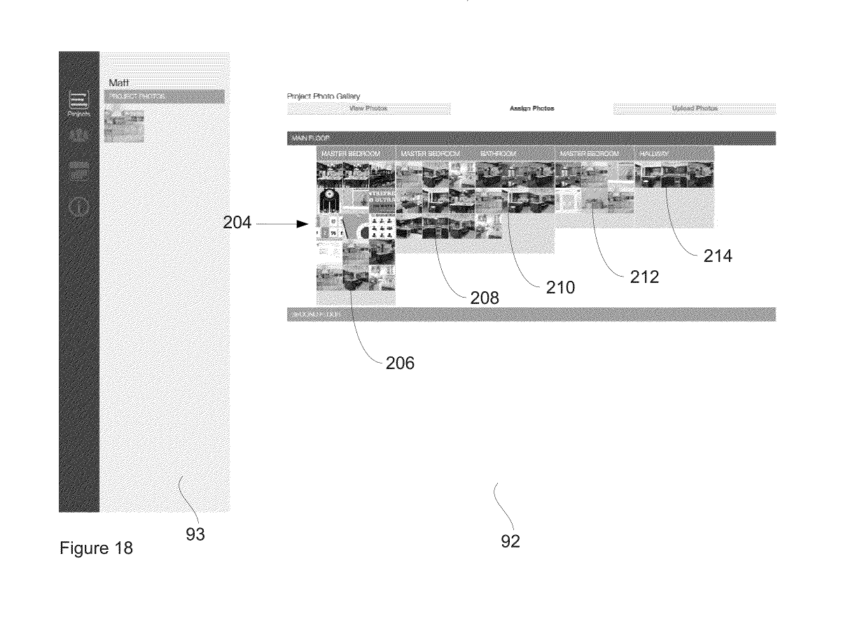

In FIG. 18, there is shown an exemplary screenshot depicting information pertaining to the project “Matt” 150 in which objects, such as communications, notes, media, data to each ‘Place’ may be assigned by dragging dropping the objects from the intermediate portion 93 to the appropriate place in the second portion 92, allowing for quick and easy assignments and all data captured and organized in terms of the place. Objects, such as, information, communications, people, times, work, tasks, notes, media, and other data in left pane can be dragged & dropped into containers for each place, such as spaces on a main floor. For example, FIG. 17 shows a photographic image gallery 204 with photographic images (“photos”) 206 associated with a first master bedroom, photos 208 associated with a master bedroom, photos 210 associated with a bathroom, photos 212 associated with a second master bedroom and photos 214 associated with a hallway.

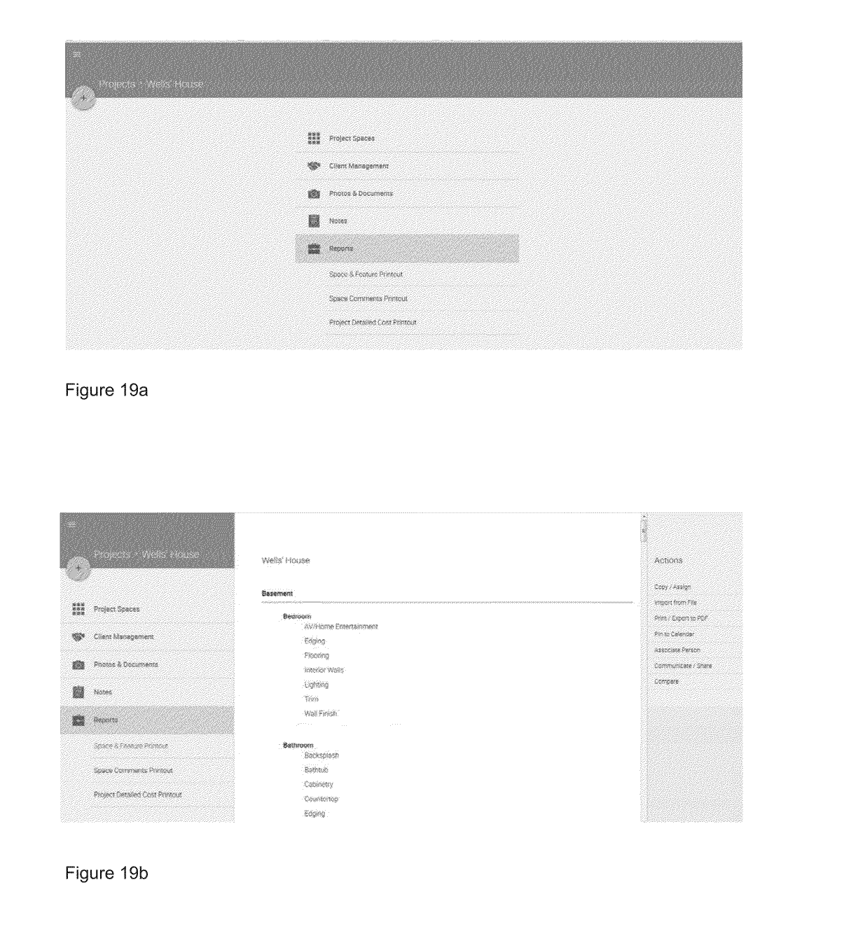

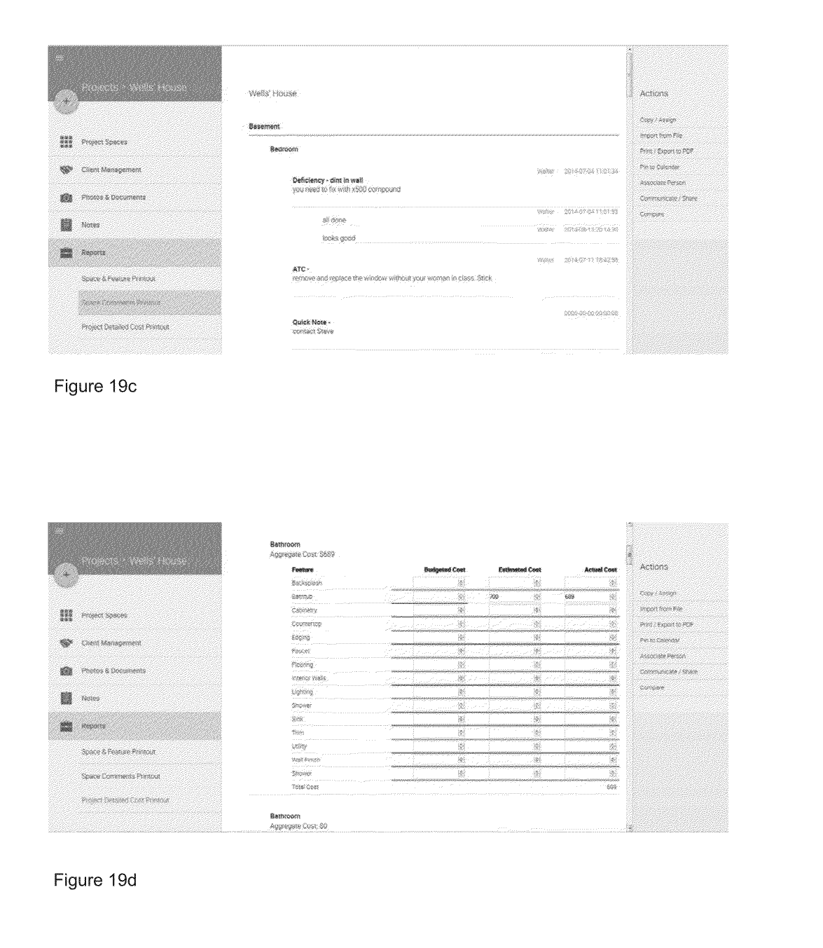

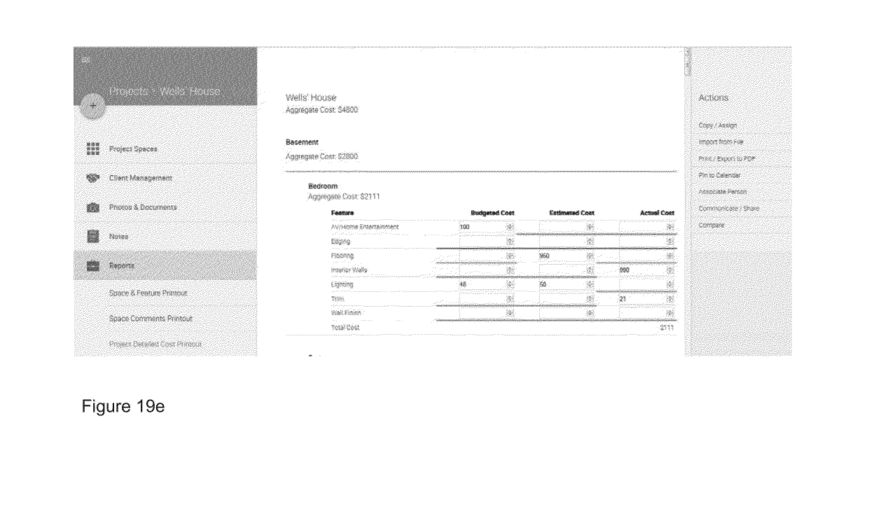

Looking at FIGS. 19a to 19e, there is shown a plethora of reports related to a place that can be provided. For example, with 8 peripheral project information elements 79 related to Place 78, there are 256 combinations of reports plus one report with place only without any elements 79. Exemplary reports include: Dates and People about a Place; Costs and People about a Place; Tasks and people about a Place; Features and people about a Place; Attributes and people about a Place; Communications and people about a Place; Notes and people about a Place.

Other exemplary reports include: Dates and Costs about a Place; Tasks and Costs about a Place; features and Costs about a Place; attributes and Costs about a Place; communications and Costs about a Place; notes and Costs about a Place.

Yet other exemplary reports include: Dates and Tasks about a Place; Features and Tasks about a Place; Attributes and Tasks about a Place; Communications and Tasks about a Place; Notes and Tasks about a Place.

Yet other exemplary reports include: Features and Communications about a Place; Attributes and Communications about a Place; Dates and Communications about a Place; Notes and Communications about a Place; Features and Notes about a Place; Attributes and Notes about a Place; Dates and Notes about a Place; Features, Notes, and People about a Place; Attributes, Notes, and People about a Place.

Therefore, place-centric project information becomes increasingly useful as the individual project information element 79 components (information or data that comprise each element) receive status and priority markers or values such that a “Place” 78 can have due dates, reminders, groups, and warnings/alarms applied that trigger or report on a plurality of criteria, much like calendar reminders or tasks in typical project management systems that use time, task, people, costs or dates as their centricity as opposed to “Place” 78.

In one example, a construction manager is able to determine the trades people who are scheduled to arrive at a project site and perform work in a bathroom renovation as opposed to the kitchen for a given date. A report listing the trades people (Project information element) and their scheduled date for the bathroom (Place) is generated. Similarly, the manager may choose to view the same criteria only using a different Place i.e. Kitchen instead of Bathroom which yields a new list generated. In fact, the manager can look across all Projects to see the same type of report i.e. determine trades that are scheduled to arrive on a given date for all Kitchens or Bathrooms.

A plurality of queries is possible, and yield associated detailed reports. Exemplary queries include: “All Kitchens and Bathrooms with Granite Counter Tops more than $2000”; “All Rooms with Extras on the second floor”; or “All Bedrooms with Deficiency Notes”. User inputs project element information in a natural way during a workflow into a Place Container whereto the information relates. The project element information is classified and automatically assigned to the Place in which it has been input by the user. The project element information or data input in the place can be served up in a multitude of useful way i.e. reports, views, management, or reference all within the structure of one application without having to compile the information or data from other free-form software applications. Place centricity affords project element information to share a common relationship.

Electronic message corresponding to a project may be initiated, compiled, and exchanged between stake holders according to exemplary method steps comprising: initializing a window on a graphical user interface to include a place object associated with a location of said project; responsive to user selection of the place object, displaying an object attributes window including at least one project element type associated with the place object and a plurality of selectable attributes associated with said at least one project element type; responsive to user selection of one or more attributes, associating selected attributes with the place object and the at least one project element type; initializing an editable free-form user interface element, and populating the free-form user interface element with the place object, the at least one project element type and associated the plurality of selectable attributes. The electronic message comprises said place object is an originator of message, and at least one of the selectable attributes form a subject of the electronic message, and the free-form content forms a body of said message; and the electronic message pertains to one of the place object and at least one of the selectable attributes, and one of the place object and at least one of the selectable attributes is central to the communication method, such that communication between users is place-centric rather than user-centric.

In one example, suppose that a stakeholder of Project ACME desires to send a message related to the cafeteria washroom (Sub place 1c), then the originator of the message would be “PROJECT ACME-Ground Floor-Cafeteria-Washroom”. The body of the message would include some descriptive text pertaining to the topics related to the cafeteria washroom, such as any attributes (characteristics of a place) e.g. metrics (height, length, width) pertaining to the place and portals (openings that lead to other space containers such as structures, floors, places and sub-places) e.g. windows, doors, stairways/elevator ways of the cafeteria washroom itself, and/or including but not limited to the: area of the walls; area of the floors; area of the ceiling; thickness of wall(s)/floor(s)/ceiling(s)/structure(s); or any feature (objects within a place), such as floor tile, stalls, sinks, and their respective features or attributes. Also included in the body may be thumbnail views of the floor tiles, stalls or sinks, and these thumbnail views may be actuated by a pointing device to launch a page view of the floor tile, stall or sink, similar to the page view of FIG. 17. On that page view, notes may be entered by stakeholders, and these notes are assigned a time-stamp, and include the stakeholder responsible for the notes, and IP address of the stakeholder's device, among others, for an audit trail. In another example, suppose the stakeholder desires to send a message related to the cafeteria warehouse (Sub place 1a), and the cafeteria (Sub place 1b) then the originator might be “PROJECT ACME-Warehouse+Cafeteria”, such that the message may originate from one or more places and/or one or more sub-places, as desired.

In yet another embodiment, full audit trails are generated for all transactions to analyze irregularities or any detail of interest, or for security purposes.

In another embodiment, the method and system as described may be useful for managing projects related to construction, renovation, remodeling, interior design; construction; architecture, engineering, commercial, manufacturing, institutional, government, healthcare, education, law enforcement, military, event planning, movie entertainment and production, consumer and travel industries.

In another embodiment, other modules pertaining to billing, accounting, and purchase orders may be included.

Server computer 14 includes a computer system with elements similar to those described above with reference to user device 12. Server computer 14 may be a web server (or a series of servers) running a network operating system, examples of which may include but are not limited to: Microsoft® Windows® XP Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

Server computer 14 may execute a web server application, examples of which may include but are not limited to: Microsoft IIS, Novell Webserver™, or Apache® Webserver, that allows for HTTP (i.e., HyperText Transfer Protocol) access to server computer 14 via network 16 (Webserver is a trademark of Novell Corporation in the United States, other countries, or both; and Apache is a registered trademark of Apache Software Foundation in the United States, other countries, or both). Network 16 may be connected to one or more secondary networks (e.g., network 16), examples of which may include but are not limited to: a local area network; a wide area network; or an intranet, for example.

Database 20 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention. Alternatively, database 20 is communicatively coupled to server computer 14.

The user devices 12 and server 14 may communicate with each other using network-enabled code. Network enabled code may be, include or interface to, for example, HyperText Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMWL), Wireless Markup Language (WML), Java™, Java™ Beans, Enterprise Java™ Beans, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

While the project management module 18 is shown and described as residing on, and being executed by, server computer 14, other implementations may equally be utilized. For example, the project management module may be a client-side process stored on one or more storage devices resident on, or coupled to one or more client user devices 12. In such an implementation, the project management module 18 may be a stand-alone application or an applet/application that is executed within a client application. As such, project management module 18 may be a server-side process executed on server computer 14, a client-side process executed by one or more client user devices 12, or a hybrid client-side/server-side process, executed in part by server computer 14 and one or more client user devices 12.

In another embodiment, system 10 may be an enterprise system.

One or more portions of the computer system 12 may be distributed across one or more computer systems coupled to a communications network. This computer system 12 also may be general-purpose computer system. The computer system 12 may be in the form of any kind of general processing structure, and may for example include any device, such as, a personal computer, laptop, tablet, computer server, personal digital assistant (PDA), cellular phone, smartphone. For example, various aspects of the invention may be distributed among one or more computer systems (e.g., servers) configured to provide a service to one or more client computers, or to perform an overall task as part of a distributed system. For example, various aspects of the invention may be performed on a client-server, hybrid client-server, or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

The communications network 16 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1. A computer program product comprising a non-transitory computer readable medium embodying computer readable code for creating an electronic message corresponding to a project, said computer program product comprising:
computer readable code for creating a window on a graphical user interface to include at least one location and at least one sub-location pertaining to said project and at least one project element type pertaining to one of said location and said at least one sub-location;
responsive to user selection of said at least one location and said at least one sub-location, computer readable code for displaying an object attributes window including a plurality of selectable attributes associated with said at least one location, said at least one sub-location;
responsive to user selection of one or more selectable attributes, computer readable code for associating selected attributes with said at least one location and said at least one sub-location and said at least one project element type object;
computer readable code for creating an editable free-form user interface element for population with said at least one location, said at least one selectable sub-location, said at least one object type and said plurality of selectable attributes associated therewith;
wherein said electronic message comprises said at least one location as an originator of said message, and one of said sub-locations and said at least one of said selectable attributes forms a subject of said electronic message, and said free-form content forms a body of said message; and
wherein said electronic message pertains to one of said at least one location and at least one of said plurality of selectable attributes, and wherein one of said at least one location and at least one of said plurality of selectable attributes is central to said communication method.

2. The computer program product of claim 1, wherein said at least one project element type comprises resources associated with said project including at least of one of time, personnel, equipment, products, and services.

3. The computer program product of claim 2, wherein said selectable attributes comprise at least one of features, metrics, descriptive information, communications, notes, and media.

4. The computer program product of claim 3, wherein said electronic message is stored in a central data repository to enable collaboration between project participants, and said electronic message forms the only working copy.

5. The computer program product of claim 4, wherein said electronic message is provided to at least one project participant; and
wherein said at least one of said one project participant updates said message with changes by following said at least one of said aforementioned steps, such that an updated version of said working copy is created by committing to said central data repository any of said changes performed in said working copy.

6. The computer program product of claim 5, wherein a changeset is associated with said changes, and stored in said central data repository.

7. The computer program product of claim 6, wherein having said at least one location as said originator of said message provides a location-centric communication method rather than a project participant-centric communication method.

8. The computer program product of claim 7, wherein said project comprises at least one task with a plurality of sub-tasks in a workflow process, wherein said location-centric communication is based on said at least one location and said at least one sub-location where said at least one task is performed.

9. The computer program product of claim 8, wherein said at least one location includes at least one first attribute chosen from said plurality of selectable attributes.

10. The computer program product of claim 9, wherein said at least one sub-location includes at least one second attribute chosen from said plurality of selectable attributes.

11. The computer program product of claim 10, wherein said at least one object type includes said at least one third attribute chosen from said plurality of selectable attributes.

12. A communication method associated with a project, said project having at least one task with a plurality of sub-tasks in a workflow process, the method having the steps of:
determining a location and at least one sub-location where said at least one task is performed;
organizing at least one project element type pertaining to said project, wherein said at least one project element type comprises resources associated with said project including at least of one of time, personnel, equipment, products, and services;
assigning a first attribute to said location and a second attribute to said at least one sub-location, at a third attribute to said at least one of object type, wherein any of said first attribute, said second attribute and third attribute comprises at least one of features, metrics, descriptive information, communications, notes, and media;
presenting on a user interface a title of said project, said location and at least one selectable sub-location and at any of said first attribute, said second attribute and third attribute;
composing a message related to one of said location and at least one of said selectable attributes by:
selecting at least one of said sub-locations and selecting at least one of said attributes for populating an editable free-form user interface element; and
wherein said message comprises said location as an originator of said message, and one of said sub-locations and said at least one of said attributes forms a subject of said message, and said free-form content forms a body of said message; and
wherein said location and associated at least one of said selectable attributes is central to said communication method, such that said communication method is location-centric rather than user-centric.

13. The communication method of claim 12, comprising a further step of providing said message to at least one project participant; and
whereby said at least one project participant updates said message by following at least one of said aforementioned steps.

14. The communication method of claim 13, wherein said workflow process is customized for said project, and at least one of project element type and said at least one selectable attribute is specific to said project.

15. The communication method of claim 14, wherein said workflow process is customized for a field of at least one of construction, renovation, remodeling, interior design; construction; architecture, engineering, commercial, manufacturing, institutional, government, healthcare, education, law enforcement, military, event planning, movie entertainment and production, consumer and travel.

16. In a project management system, a computer-implemented method for managing information related to at least one project, said method having instructions stored in a computer-readable medium and executable by a processing structure to cause said processing structure to at least:
assign a user defined project identifier to said at least one project;
assign a unique place identifier to a location of said at least one project, and storing said unique place identifier to form a first level of a hierarchical data structure in a database;
assign a unique sub-place identifier to at least one sub-location of said at least one project, and storing said unique sub-place identifier to form a second level of said hierarchical data structure in said database;
assign a unique element identifier to at least one project element associated with said location and/or sub-location, said at least one project element having at least one feature, and storing said unique element identifier to form a third level of said hierarchical data structure in said database;
capture information pertaining to one said at least one project and assign said captured information to any one of said location and/or sub-location and attribute, and project element; and
whereby said assigned information is organized in terms with respect to said at least one location and/or said at least one sub-location.

17. The system of claim 16, wherein said at least one project element comprises at least one of costs, tasks, communication, features, attributes, time, people, date, and notes, and said at least one project element being centered about said at least one location and/or said at least one sub-location.

18. The system of claim 17, wherein said workflow process is customized for said project, wherein said workflow process is customized for a field of at least one of construction, renovation, remodeling, interior design; construction; architecture, engineering, commercial, manufacturing, institutional, government, healthcare, education, law enforcement, military, event planning, movie entertainment and production, consumer and travel.

19. The system of claim 18, wherein said at least one of project element type and said at least one of said attributes is specific to said project, and wherein said electronic message is provided to at least one project participant, and wherein said message pertains to said at least one location and/or said at least one sub-location, such that said message is location-centric rather than project participant-centric.

20. In a data processing system for a project management platform, a computer-implemented method for capturing data pertaining to at least one location of a project, the method having instructions stored in a computer-readable medium and executable by a processing structure to cause said processing structure to at least:
provide access to at least one user to said platform, wherein said at least one user has a predetermined user access privilege level to said platform;
present a graphical user interface (GUI) having a plurality of GUI objects for navigating said platform;
provide at least one input field for entering information pertaining to a title of said project, and assign a first unique identifier to said title of said project;
allow input of information pertaining to at least one location of said project, and assign a second unique identifier to said at least one location;
allow input of information pertaining to at least one sub-location of said at least one location of said project; and assign a third unique identifier to said at least one sub-location;
allow input of information pertaining to at least one attribute of said at least one sub-location of said at least one location; and assign a fourth unique identifier to said at least one attribute; and
whereby said title of said project, said at least one location, said at least one sub-location and said at least one attribute form a location-centric hierarchical structure of information pertaining to said project.

21. The computer-implemented method of claim 20, wherein said project comprises at least one task having a plurality of sub-tasks, and wherein said at least one task is performed in at least one of said at least one location and at least one sub-location.

22. The computer-implemented method of claim 21, wherein said project management platform comprises:
a project participants module having the functions of receiving and managing details of project stakeholders, such as contractors, sub-contractors, project team, vendors, trades, and clients; adding a project participant to a project team; assigning unique identifiers to members of said project team; and defining project roles of said project team;
a project place module having the functions of defining project locations; managing location-centric information related to locations or sub-locations for which project resources are bound;
a project calendar module having the functions of managing project milestone dates, allowing said project participants to identify major project milestones, enter new milestone activities; identify schedule tasks; add new schedule task; add a start date and an end date; and calculate schedule dates based on input of task data;
an Request for Quotes (RFQ) module having the functions of managing RFQs, and transmittals, submittals, change orders and deficiency lists associated with said RFQs; providing to said project participants, any of a summary and/or an overview of requirements and list of proposers, details describing the scope of services requested; providing quotes based on predetermined criteria and fee analysis to allow said project participants to determine variances between estimated, actual and other costs;
a media module having the functions of uploading and cataloguing of documents, images and multimedia; and providing linking of project specific information, including at least one of a title, description, daily report, and schedule;
an analytics and reporting module having the functions of analyzing information related to said project and generating reports, including at least one of a histogram, time line, bar chart, and tabular data; and providing forecasting based on resource constraints;
a communications module having the functions of exchanging and sharing of notes, multimedia, documents, comments between said project participants in a collaborative manner;
a search module having the functions querying data captured within said project management system; and
a project module having the functions of providing a summary of common project information to said project participants; providing task information to said project participants; sharing common data; providing a scope describing said project;
identifying members of a project team; providing basic project data; assigning unique identifiers to each project or sub-project, place or sub-place associated with said project or sub-project and storing said unique identifiers in a database;
whereby said project information is organized by location; and
whereby said information and communications are captured in the context of a location targeted for said task in relation to said place it pertains to, to form a location-centric hierarchical structure of information pertaining to said project.
